(19) United States
(12) Patent Application Publication
(10) Pub. No.: US 2015/0243037 A1
(43) Pub. Date: Aug. 27, 2015

(54) METHOD FOR A DISTANCE MEASUREMENT

(71) Applicant: JESurpass CO., Taipei (TW)

(72) Inventor: Miao-Bin Su, Taipei (TW)

(21) Appl. No.: 14/623,754

(22) Filed: Feb. 17, 2015

(30) Foreign Application Priority Data
Feb. 24, 2014 (TW) 103106108

(51) Int. Cl. G06T 7/00; G06K 9/00; G06K 9/22; H04N 5/225

(52) U.S. Cl. CPC G06T 7/0065; H04N 5/2257; G06K 9/00664; G06K 9/22; G06T 2207/10028

(57) ABSTRACT

A method for a distance measurement is provided, which is adapted to a mobile device that has an image capture module. The image capture module has an image information including an image width, an image height and a image angle. The method determines an capture angle between the target and the mobile device according to the image information, and calculates a distance to the target by using the capture angle with Trigonometry. Therefore, the present invention is able to measure the distance of a target remotely simply by taking pictures from any mobile device.

### FIELD OF THE INVENTION

The present invention is related to a method for a distance measurement, especially to a measuring method that uses the mobile device.

### BACKGROUND

For remote distance measurements, the common way is using a telescope to estimate distance by comparing the image size and the known actual size of the target object. A known product such as a golf distance measurer that helps golf play to measure distances. The drawback of such product is that the accuracy is limited by the resolution of the device, and the resolution take effects on the cost. However, the laser distance sensor may be another option for high accuracy but can be very expensive and the sensing range is also limited.

Thus, there is a need for a remote distance measurement which a distance of target can be measured without knowing the size of the target object, and also provides broader measuring range with lower cost.

### SOME EXEMPLARY EMBODIMENTS

According to an object of the present invention, an embodiment is provided for a method to measure a distance between a person and a target using an image capture module of a mobile device.

According to an embodiment of the present invention, a method is adapted of using a mobile device for a distance measurement, the mobile device has an image capture module, a global position system module and a gyroscope sensor. The method comprises acts of capturing a reference image of a target using the image capture module respectively for a first position and a second position in sequence, determining a reference distance between the first position and the second position by the global position system module, determining an angle difference of the two reference images by the gyroscope sensor, and calculating a distance of the target using the reference distance and the angle difference based on a predetermined rule.

According to another embodiment of the present invention, a method for a distance measurement of using an image capture module of a mobile device, the image capture module has its own optical range including an optical height, an optical width and an optical angle. The method comprises acts of providing a positioning point that is heading straight toward a target, and capturing the target within a reference image in a longitudinal direction at a capturing point. The capturing point is a point that latitudinally offsets from the positioning point and has a reference distance in between. The method further comprises acts of determining a horizontal distance in the reference image from the target to the central axis of the reference image, using the horizontal distance, the optical width and the optical angle to determine an angle difference, and calculating a distance of the target using the reference distance and the angle difference based on a predetermined rule.

According to other embodiment of the present invention, a method for a distance measurement of using an image capture module of a mobile device, the image capture module has its own optical range including an optical height, an optical width and an optical angle. The method comprises act of capturing a reference image of a target by the image capture module, wherein the actual height from a top and a bottom of the target is known. The method further comprises acts of determining a virtual height between the top and the bottom of the target in the reference image, using the virtual height, the optical height and optical angle to determine an angle difference, and calculating a distance between the target and the image capture module by the angle difference and the actual height based on an predetermined rule.

Accordingly, embodiments of the present invention is able to remotely determine a target distance simply by taking pictures, from any mobile device that has an image capture module, without actually going to the location of the target.

### BRIEF DESCRIPTION OF THE DRAWINGS

The above objects and advantages of the present invention will become more readily apparent to those ordinarily skilled in the art after reviewing the following detailed description and accompanying drawings, in which:

FIG. 1 is FIG. 1 is a flowchart of an embodiment in accordance with the present invention;

FIG. 2 is a diagram illustrating the implement of the embodiment in FIG. 1 in accordance with the present invention;

FIG. 3 is a flowchart of another embodiment in accordance with the present invention; and

FIG. 4 is a diagram illustrating the implement of the embodiment in FIG. 3 in accordance with the present invention.

### DESCRIPTION OF THE PREFERRED EMBODIMENT

Some embodiments of the present invention will now be described in detail. Nevertheless, it should be recognized that the present invention can be practiced in a wide range of other embodiments besides those explicitly described, and the scope of the present invention is expressly not limited except as specified in the accompanying claims.

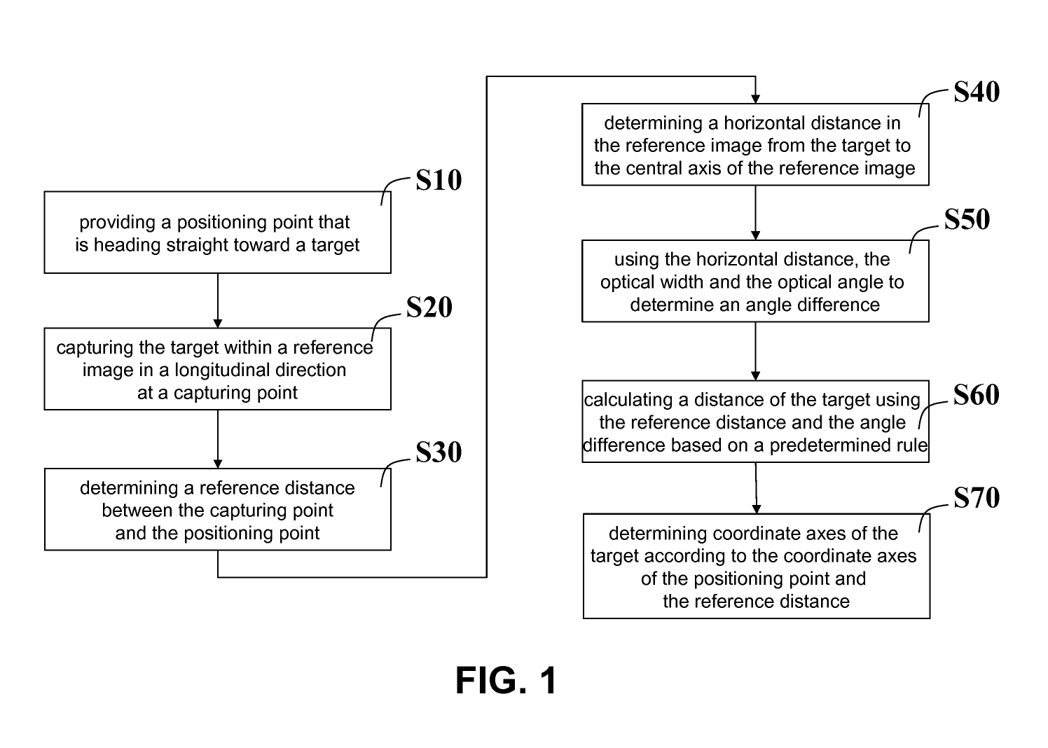

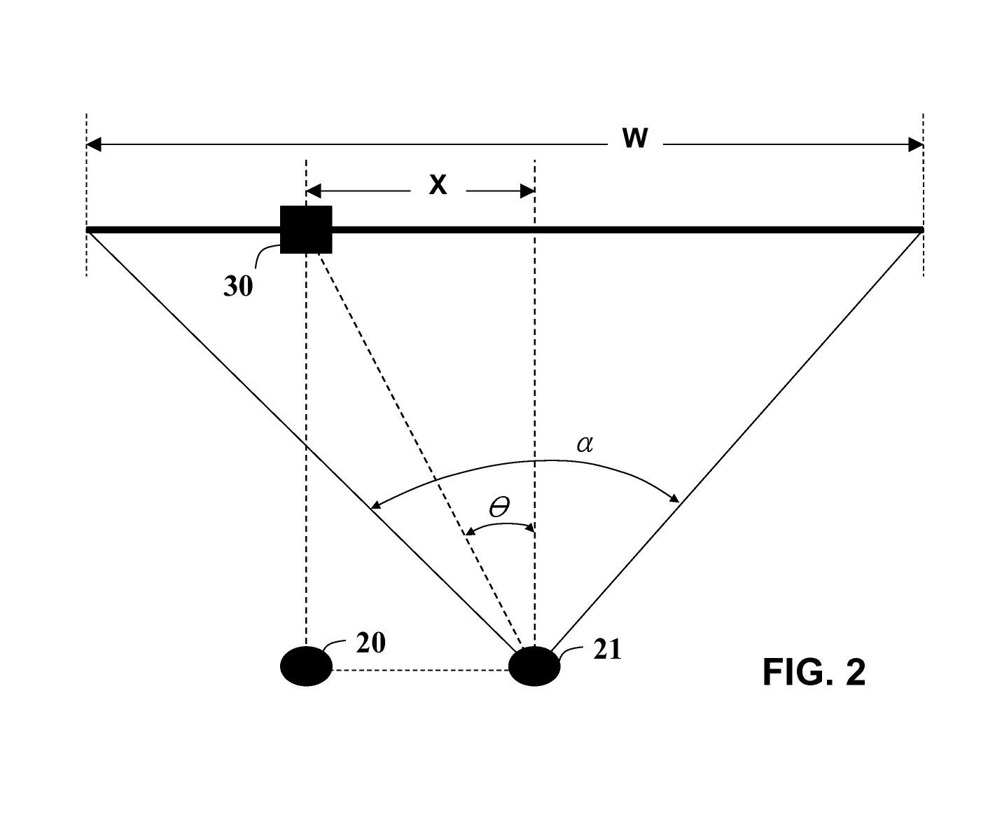

With reference to FIGS. 1 and 2, FIG. 1 is a flowchart of an embodiment in accordance with the present invention, and FIG. 2 is a diagram illustrating the implement of the embodiment in FIG. 1. In this embodiment, the invention is implemented of a mobile device that has an image capture module such as smart phone, a camera or a pad computer.

According to this embodiment, as shown in FIG. 1, the a method for a distance measurement of using an image capture module of a mobile device, the image capture module has its own optical range including an optical height, an optical width and an optical angle. The method comprises acts of S10 providing a positioning point that is heading straight toward a target, S20 capturing the target within a reference image in a longitudinal direction at a capturing point, and S30 determining a reference distance between the capturing point and the positioning point, where the capturing point is a point that latitudinally offsets from the positioning point. The method further comprises acts of S40 determining a horizontal distance in the reference image from the target to the central axis of the reference image, S50 using the horizontal distance, the optical width and the optical angle to determine an angle difference, and S60 calculating a distance of the target using the reference distance and the angle difference based on a predetermined rule.

In an embodiment, the act S60 of the predetermined rule may be a following relation of the distance of the target, the reference distance and the angle difference:

$$D = \frac{{D}_{o}}{tan θ} ,$$

wherein the D is the distance of the target, Dₒ is the reference distance and Θ is the angle difference.

FIG. 2 is illustrating an example using the acts of FIG. 1 for better understanding of the present invention. In this example, a person, firstly, may stand at a positioning point 20 and face to a desired target for distance measurement. As described in acts of S10, the image capture module of the mobile is heading straight toward the target 30. In an actual practice, the person may aiming the target 30, and then makes the target placed in the central axis of the optical width W of the image capture module. Alternatively, the person may manually label the target 30 with an absolute position in the taken images (i.e., photo) or determining a relative position of the target by predefined feature sampling points.

Secondly, as described in acts of S20, the person then moves to a capturing point 21 from the positioning point 20, and captures the target 30 within a reference image (i.e., photo) in a longitudinal direction at a capturing point 21. The distance between the positioning point 20 and the capturing point 21 can be any value, the method of the present invention can accept any length of the distance of the two points 20, 21.

Since the distance of the positioning point 20 and the capturing point 21 is defined by the person, the acts S30 of determining a reference distance between the capturing point and the positioning point can be achieved in many way. One way is to let the person manually enter a specific value of the reference distance. Another way is to use the global positioning system (GPS) module or the gyroscope sensor for determining the reference distance. The GPS module is able to get the actual global coordinates of the capturing point 21 and the positioning point 20, and provides the absolute distance of the two points. The gyroscope sensor is able to sense the relative distance of the capturing point 21 and the positioning point 20 when the person is moving.

After obtaining the reference distance, the acts of S40 calculates the horizontal distance from the target to the central axis of the reference image. However, it is also noted the acts of S40 may implement in similar manners as described above of S20. The horizontal distance may be determined by manually label the target 30 with an absolute position or retrieved a relative position of the target by predefined feature sampling points.

The reason behind obtaining the horizontal distance of the target in the reference image, we can use the relationship of the orthographic projection to calculate the angle difference between the target and the central axis of the optical width, since the optical width and the optical angle are known value. The relationship can be expressed as following:

$$θ = α * \frac{x}{w} ,$$

wherein Θ is the angle difference, a is optical angle, W is optical width and X is the horizontal distance.

Once the angle difference and reference distance are determined, the embodiment of the present invention is able to calculate the distance between the person (i.e., the positioning point 20) and the target 30 as above described in acts of S60.

In another embodiment, the method further comprises act of S70 determining coordinate axes of the target according to the coordinate axes of the positioning point and the reference distance.

One great benefit is that once the coordinate axes of the target and the positioning point are obtained, the method in accordance with the present invention is able to collocate with the any existing map navigating route service or system. In general, the existing navigating route service requires a person to enter desired address, coordinates or names of the target, but sometimes it bothers tourists, because they don't know the address not even the name of the target. They can only ask local person or search for a suspect spot in the map.

On the contrary, using the method in accordance with the embodiments of the present invention, a person (e.g., a tourist) may simply take out his/her mobile phone or camera to get the coordinate of the target by implementing the acts of S10 to S70 above described.

Further, as progress of the technologies, the functions of the mobile device is improving everyday, and the accuracies of the GPS module and the gyroscope sensor are also improved. By providing suitable programmed software and/or apps, the acts of the method can be automatically integrated. For example, the gyroscope sensor is able to sense the shooting angles directly to determine the angle difference, and the GPS module is able to calculate the displacement of the positioning point and the capturing point directly.

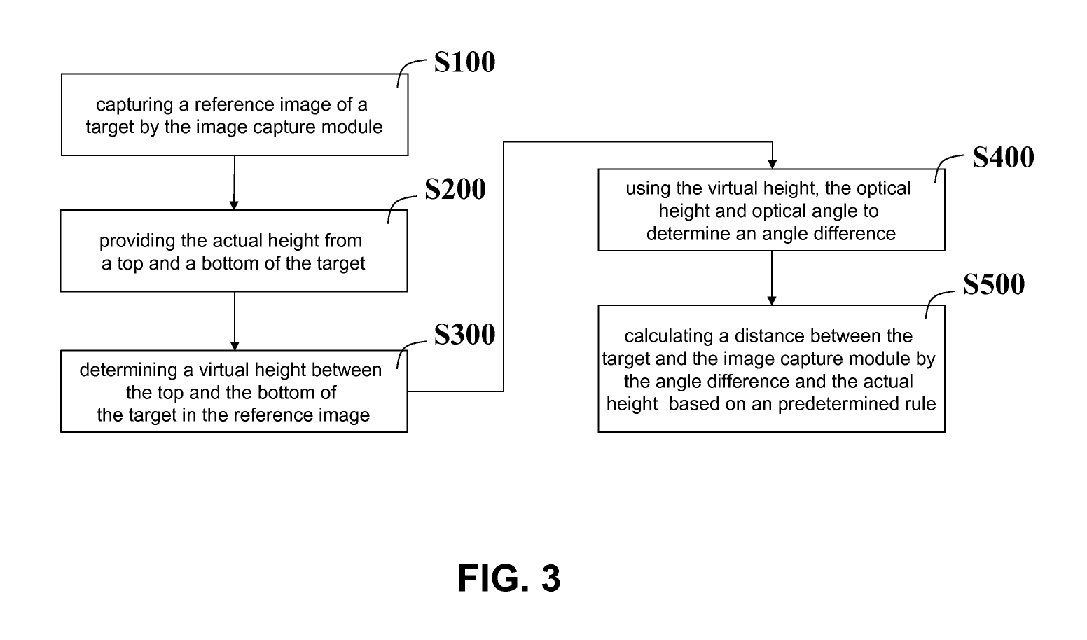

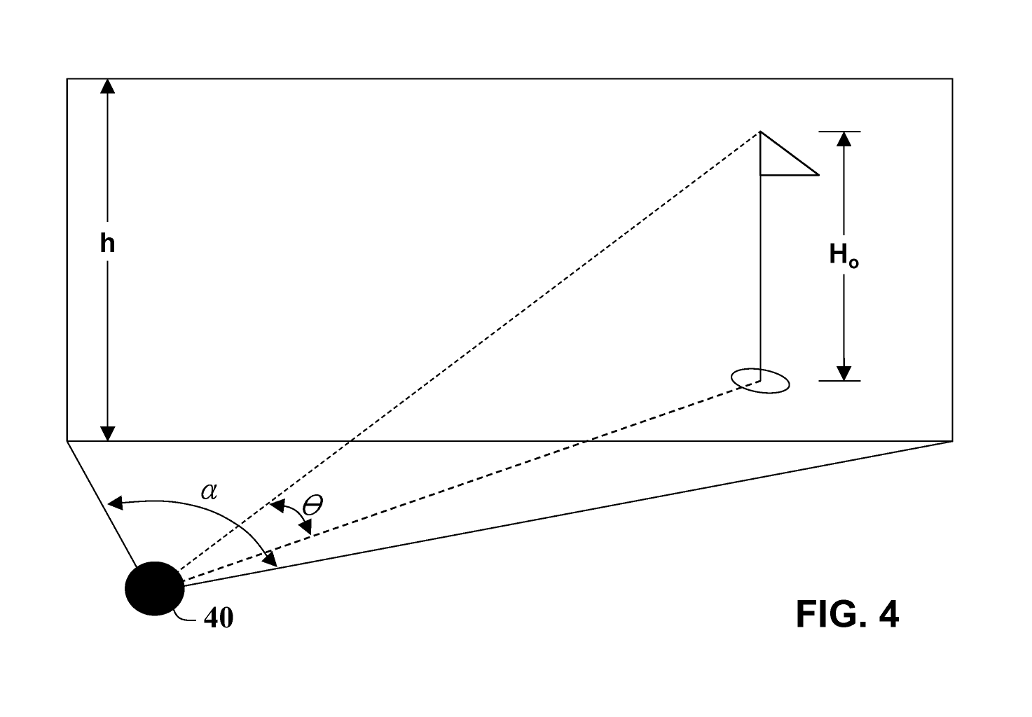

With reference to FIGS. 3 and 4, FIG. 3 is a flowchart of another embodiment in accordance with the present invention, and FIG. 4 is a diagram illustrating the implement of the embodiment in FIG. 3. In this embodiment, the method is adapted for a target with known target height. Similar to above mentioned embodiment, the method is used in a mobile device with an image capture module. The image capture module has its own optical range including an optical height, an optical width and an optical angle. The method comprises acts of S100 capturing a reference image of a target by the image capture module, and S200 providing the actual height from a top and a bottom of the target. The method further comprises acts of S300 determining a virtual height between the top and the bottom of the target in the reference image, S400 using the virtual height, the optical height and optical angle to determine an angle difference, and S500 calculating a distance between the target and the image capture module by the angle difference and the actual height based on an predetermined rule.

For example, the method can be adapted for golf course that a player 40 can measure the distance from the swing spot to the flag (i.e., the location of the ball hole). As shown in FIG. 4, the parameters of the optical range of the image capture module (i.e., optical angle and optical height), and the actual height and virtual height of the flag are known. The acts of S400 is able to use the orthographic projection to calculate the angle difference expressed as following:

$$θ = α * \frac{H}{h} ,$$

wherein Θ is the angle difference, a is the optical angle, h is optical height and H is the virtual height of the flag.

Once the angle difference is obtained, the acts of S500 can use the trigonometric function to calculate the target distance, and can be expressed as following:

D=Hₒ cos θ,

wherein D is the distance of the target, Θ is the angle difference and Hₒ is the actual height of the flag.

Therefore, embodiments of the present invention is able to remotely determine a target distance simply by taking pictures, from any mobile device that has an image capture module, without actually going to the location of the target.

Although specific embodiments have been illustrated and described, it will be obvious to those skilled in the art that various modifications may be made without departing from what is intended to be limited solely by the appended claims.

What is claimed is:

1. A method for a distance measurement adapted to a mobile device having an image capture module, a global position system module and a gyroscope sensor, and the method comprising acts of:
capturing a reference image of a target using the image capture module respectively for a first position and a second position in sequence;
determining a reference distance between the first position and the second position by the global position system module;
determining an angle difference of the two reference images by the gyroscope sensor; and
calculating a distance of the target using the reference distance and the angle difference based on a predetermined rule.
The method as claimed in claim 1, wherein the predetermined rule is expressed as
$$D = \frac{{D}_{o}}{tan θ} ,$$
wherein D is the distance of the target, Dₒ is the reference distance and Θ is the angle difference.
A method for a distance measurement of using an image capture module of a mobile device that has its own optical range including an optical height, an optical width and an optical angle, and the method comprising acts of:
providing a positioning point that is heading straight toward a target;
capturing the target within a reference image in a longitudinal direction at a capturing point;
determining a reference distance between the capturing point and the positioning point, wherein the capturing point is a point that latitudinally offsets from the positioning point;
determining a horizontal distance in the reference image from the target to the central axis of the reference image;
using the horizontal distance, the optical width and the optical angle to determine an angle difference; and
calculating a distance of the target using the reference distance and the angle difference based on a predetermined rule.
The method as claimed in claim 3, wherein the predetermined rule is expressed as
$$D = \frac{{D}_{o}}{tan θ} ,$$
wherein D is the distance of the target, Dₒ is the reference distance and Θ is the angle difference.
The method as claimed in claim 3, wherein the angle difference is determined by a relationship according to the optical angle, optical width and the horizontal distance, and the relationship is expressed as
$$θ = α * \frac{x}{w} ,$$
wherein Θ is the angle difference, a is optical angle, W is optical width and X is the horizontal distance.
The method as claimed in claim 3, wherein the mobile device further has a global positioning system module or a gyroscope sensor for determining the reference distance.
The method as claimed in claim 3, wherein the mobile device further has a global positioning system module or a gyroscope sensor for determining a coordinate of the target.
The method as claimed in claim 7, further comprising act of:
determining coordinate axes of the target according to the coordinate axes of the positioning point and the reference distance.
A method for a distance measurement of using an image capture module of a mobile device that has its own optical range including an optical height, an optical width and an optical angle, and the method comprising acts of:
capturing a reference image of a target by the image capture module;
providing a known actual height from a top to a bottom of the target;
determining a virtual height between the top and the bottom of the target in the reference image;
using the virtual height, the optical height and optical angle to determine an angle difference; and
calculating a distance between the target and the image capture module by the angle difference and the actual height based on an predetermined rule.
The method as claimed in claim 9, wherein the angle difference is determined by a relationship according to the optical angle, optical height and the virtual height of the target, and the relationship is expressed as
$$θ = α * \frac{H}{h} ,$$
wherein Θ is the angle difference, a is the optical angle, h is optical height and H is the virtual height of the target.
The method as claimed in claim 9, wherein the predetermined rule is expressed as
D=Hₒ cos θ,
wherein D is the distance of the target, Θ is the angle difference and Hₒ is the actual height of the target.
